(19) United States
(12) Patent Application Publication
(10) Pub. No.: US 2025/0291963 A1
(43) Pub. Date: Sep. 18, 2025

(54) Scanned Digital Twin Correction Using Constraint Optimization

(71) Applicant: PassiveLogic, Inc., Holladay, UT (US)

(72) Inventors: Troy Aaron Harvey, Holladay, UT (US); Jeremy David Fillingim, Holladay, UT (US); Porter Jonas Child, Holladay, UT (US); Dmitri Ivanov, Holladay, UT (US)

(21) Appl. No.: 19/224,572

(22) Filed: May 30, 2025

Related U.S. Application Data
(63) Continuation-in-part of application No. 18/496,445, filed on Oct. 27, 2023.
Application No. 18/496,445 is a continuation-in-part of application No. 17/722,115, filed on Apr. 15, 2022.
(60) Provisional application No. 63/801,647, filed on May 7, 2025.

(51) Int. Cl. G06F 30/13; G06F 16/245

(52) U.S. Cl. CPC G06F 30/13; G06F 16/245

(57) ABSTRACT

Various embodiments relate to a method, apparatus, and machine-readable storage medium including one or more of the following: creating keypaths into the digital twin that accesses a structural property stored in the digital twin; identifying a constraint for the physical structure associated with the keypaths, creating a cost function from the keypaths and the constraint; and optimizing a value for structural property using the cost function, where the structural property stored in the digital twin is corrected.

### RELATED APPLICATIONS

This application is a continuation-in-part of U.S. patent application Ser. No. 18/496,445, filed on Oct. 27, 2023, which is a continuation-in-part of U.S. patent application Ser. No. 17/722,115, filed on Apr. 15, 2022, and claims the benefit of U.S. provisional patent application No. 63/801,647, filed on May 7, 2025 the entire disclosures of which are hereby incorporated herein by reference for all purposes.

### TECHNICAL FIELD

Various embodiments described herein relate to digital twins or CAD models and more particularly, but not exclusively, correction of inaccuracies in digital twins using constraint-based solving.

### BACKGROUND

Computer aided design programs are commonly employed for enabling a user to design or capture a floorplan of a building in digital form. While for some applications, these digital models need not be structurally sound or accurate, other applications such as simulations benefit from the digital model being as correct as possible. The precision of tools for floorplan capture along with user error, however, can easily introduce inaccuracies that, if not corrected, can negatively impact the usability of the model for downstream applications.

### SUMMARY

Accordingly, there exists a need for a method for correcting inaccuracies in a captured digital model of a structure. Accordingly, various embodiments herein employ novel applications of optimization methods such as gradient descent to correct a digital twin. Specifically, the constraints to be met to correct the model may be translated to a cost function for optimization, thereby locating appropriate modifications to apply to the model to achieve the desired corrections. Various additional technical benefits will be apparent in view of the present disclosure.

Various embodiments described herein relate to a method for correcting a digital twin of a physical structure, the method including: creating keypaths into the digital twin that accesses a structural property stored in the digital twin; identifying one or more constraints for the physical structure associated with the keypath or keypaths; creating a cost function from the keypaths and the constraint; and optimizing a value for structural property using the cost function, where the structural property stored in the digital twin is corrected.

Various embodiments described herein relate to a device for creating a digital twin of a physical structure, the device including: a depth sensor; a memory; and a processor configured to: obtain, from the depth sensor, a scan data descriptive of the physical structure, convert the scan data to a digital twin, store the digital twin in the memory, create keypaths into the digital twin that accesses a structural property stored in the digital twin, identify a constraint for the physical structure associated with the keypaths, create a cost function from the keypaths and the constraint, and optimize a value for structural property using the cost function, whereby the structural property stored in the digital twin is corrected.

Various embodiments described herein relate to a non-transitory machine-readable storage medium encoded with instructions for execution by a processor for correcting a digital twin of a physical structure, the non-transitory machine-readable storage medium including: instructions for creating keypaths into the digital twin that accesses a structural property stored in the digital twin; instructions for identifying a constraint for the physical structure associated with the keypaths; instructions for creating a cost function from the keypaths and the constraint; and instructions for optimizing a value for structural property using the cost function, whereby the structural property stored in the digital twin is corrected.

Various embodiments are described where the keypaths access a plurality of like structural properties from different parts of the digital twin, and where the step of optimizing the value includes optimizing respective values of the plurality of like structural properties.

Various embodiments are described where the keypaths include a query for selecting the different parts of the digital twin from which the plurality of like structural properties are accessed.

Various embodiments additionally include creating an additional reference into the digital twin that accesses an additional structural property stored in the digital twin, where the cost function is created from the keypaths, the model reference, and the constraint.

Various embodiments are described where the constraint specifies that an angle difference between the adjacent walls within the model, as referenced via keypaths and the model reference, is to be ninety degrees.

Various embodiments are described wherein the constraint specifies that a distance between the adjacent parallel walls as described by the keypaths and the model reference, is to be equal to a value associated with an interior wall depth.

Various embodiments are described wherein the structural properties include spacing and orientations of walls represented by the digital twin.

### BRIEF DESCRIPTION OF THE DRAWINGS

In order to better understand various example embodiments, reference is made to the accompanying drawings, wherein:

FIG. 1 illustrates an example system for implementation of various embodiments;

FIG. 2 illustrates an example device for implementing a digital twin mobile suite;

FIG. 3 illustrates an example digital twin for construction by or use in various embodiments;

FIG. 4A illustrates an example interface illustrating an uncorrected floorplan;

FIG. 4B illustrates an example interface illustrating a corrected floorplan;

FIG. 5 illustrates an example hypergraph of a digital twin for creating a cost function;

FIG. 6 illustrates an example hardware device for implementing a digital twin mobile device; and

FIG. 7A illustrates a method for correcting a digital twin;

FIG. 7B illustrates an example of wall sets used by the alignment method;

FIG. 8A illustrates an example schematic of an uncorrected floorplan;

FIG. 8B illustrates an example schematic of a corrected floorplan;

FIG. 9 illustrates a block diagram with examples of cost function terms that may be used to correct a digital twin;

FIG. 10 illustrates an example constraint solver;

FIG. 11 illustrates an example hypergraph compute node that consists of lenses and constraints;

FIG. 12 illustrates a floor scanning alignment logic flow method.

### DETAILED DESCRIPTION

The description and drawings presented herein illustrate various principles. It will be appreciated that those skilled in the art will be able to devise various arrangements that, although not explicitly described or shown herein, embody these principles and are included within the scope of this disclosure. As used herein, the term, “or,” as used herein, refers to a non-exclusive or (i.e., and/or), unless otherwise indicated (e.g., “or else” or “or in the alternative”). Additionally, the various embodiments described herein are not necessarily mutually exclusive and may be combined to produce additional embodiments that incorporate the principles described herein.

When floor geometries are scanned using camera and LiDAR based approaches, the errors in the geometry recognition tend to accrue in a biased way, creating a cumulative effect, known as the geometrical drift. The geometrical drift becomes non-negligible when the floor scans are performed over a large area. On a typical device with typical lightning conditions, the drift becomes noticeable after scanning an area that corresponds to merely two to three typical US home bedrooms. The drift manifests itself as a serious inaccuracy in the floor plan geometry scan where the walls that were parallel in real world appear at a 5 to 15 degree angle with respect to each other in the picture, the wall angles appear altered by 5 to 15 degrees as well, and the doors and windows that were proportionally aligned, appear misplaced and skewered. The methods, systems, and

Methods, systems, and computer-readable media technologies discussed herein offer solutions to mitigate geometrical drift in floor geometry recognition, thereby significantly improving computer functionality. By using a cost function to correct for positional inaccuracies, and then using a neural network to solve for the cost function, both individual error associated with a single location and cumulative error across an entire structure is reduced. This, among other things, ensures structural consistency throughout the model. Distorted geometry is fixed based on architectural priors, such as orthogonal wall assumptions. These enhancements collectively improve computer functionality by enabling more reliable spatial data processing, reducing the need for manual corrections, and supporting higher-level tasks such as automated floor plan generation, navigation, and simulation in digital building environments. These improved feature recognition algorithms, powered by machine learning, also enhance a system's ability to discern and track structural elements, which contributes to more accurate and efficient data interpretation. Altogether, these improvements not only reduce geometrical drift but also extend the operational utility of scanning systems, leading to smarter, more autonomous, and functionally robust computing environments. These improvements listed herein are integrated into a practical application that allows quick and accurate alignment of scanned floorplans, among other things. The novel ideas presented herein improve scanning technology as scans that are inaccurate due to imperfections in LIDAR and/or Camera technology can be made much more accurate without changing the underlying LIDAR and/or Camera technology.

Below, we will describe the floorplan alignment procedure using keypaths, which are references used for reading and writing values into structures that represent the floorplan. In some versions there is an instance of a structure per floor. Each floor, in turn, has nested zone instance structures, zone instance structures have nested surface structures, and surface structures have nested vertex structures. A keypath or keypaths are applied to a structure, such as the floor instance, which will then give back some number of floorplan vertices in a single step, without having to go through all the nested structures. For a vertex, there is a keypath in a one-to-one correspondence.

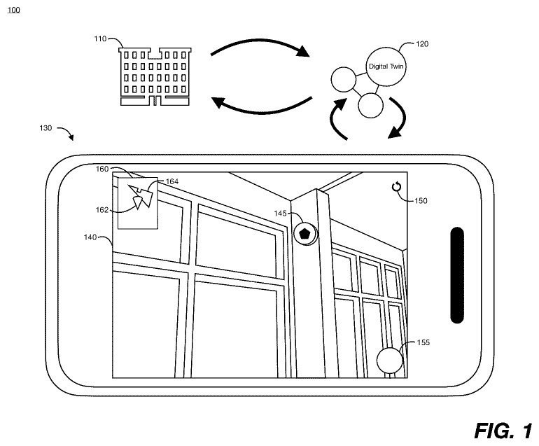

FIG. 1 illustrates an example system 100 for implementation of various embodiments. As shown, the system 100 may include an environment 110, at least some aspect of which is modeled by (or to be modeled by) a digital twin 120. The digital twin 120, in turn, interacts with a digital twin mobile suite 130 for providing a user with various means for interaction with the digital twin 120 such as creating or modifying the digital twin 120, using the digital twin 120 to commission devices deployed in the environment 110, or transmitting a copy of the digital twin 120 to one or more other devices. According to one specific set of examples, the environment 110 is a building while the digital twin 120 models various aspects of that building such as, for example, the building structure, its climate conditions (e.g., temperature, humidity, etc.), and a system of controllable heating, ventilation, and air conditioning (HVAC) equipment.

While various embodiments disclosed herein will be described in the context of such an HVAC application or in the context of building design and analysis, it will be apparent that the techniques described herein may be applied to other applications including, for example, applications for controlling a lighting system, a security system, an automated irrigation or other agricultural system, a power distribution system, a manufacturing or other industrial system, or virtually any other system that may be controlled. Further, the techniques and embodiments may be applied other applications outside the context of controlled systems or environments 110 that are buildings. Virtually any entity or object that may be modeled by a digital twin may benefit from the techniques disclosed herein. Various modifications to adapt the teachings and embodiments to use in such other applications will be apparent.

The digital twin 120 is a digital representation of one or more aspects of the environment 110. In various embodiments, the digital twin 120 is implemented as a heterogenous, omnidirectional neural network. As such, the digital twin 120 may provide more than a mere description of the environment 110 and rather may additionally be trainable, computable, queryable, and inferenceable, as will be described in greater detail below. In some embodiments, one or more processes continually, periodically, or on some other iterative basis adapts the digital twin 120 to better match observations from the environment 110. For example, the environment 110 may be outfitted with one or more temperature sensors that provide data to a building controller (not shown), which then uses this information to train the digital twin to better reflect the current state or operation of the environment. In this way, the digital twin is a “living” digital twin that, even after initial creation, continues to adapt itself to match the environment 110, including adapting to changes such as system degradation or changes (e.g., permanent changes such as removing a wall and transient changes such as opening a window).

Various embodiments of the techniques described herein may use alternative types of digital twins than the heterogenous neural network type described in most examples herein. For example, in some embodiments, the digital twin 120 may not be organized as a neural network and may, instead, be arranged as another type of model for one or more components of the environment 110. In some such embodiments, the digital twin 120 may be a database or other data structure that simply stores descriptions of the system aspects, environmental features, or devices being modeled, such that other software has access to data representative of the real world objects and entities, or their respective arrangements, as the software performs its functions.

The digital twin mobile suite 130 may provide a collection of tools for interacting with the digital twin such as, for example, tools for creating and modifying the digital twin 120; tools for using the information provided by the digital twin 120 to commission devices deployed in the environment (e.g., to activate, test, or verify the proper installation of such devices); or tools for storing the digital twin 120 (or portions thereof) to make the digital twin 120 available to other devices that may have use for it. It will be understood that while the mobile suite 130 is depicted here as a single user interface provided via a mobile device, that the mobile suite 130 includes a mix of hardware and software, including software for performing various backend functions and for providing multiple different interface scenes (such as the one shown) for enabling the user to interact with the digital twin 120 in different ways and using different tools and applications in the mobile suite 130. Further, while various embodiments are described with respect to the mobile suite 130 being implemented on a mobile device such as a mobile phone or tablet, various alternative embodiments may implement some or all of the mobile suite 130 on a non-mobile device. For example, the majority of functionality of the mobile suite 130 may be implemented on a stationary computer (e.g., a personal computer or a server) while a camera, lidar scanner, flashlight, or other supporting hardware may be provided as part of a different device that may be manipulated by the user for performing supporting mobile activities (e.g., scanning a room or performing short-range communication with a device) and communicating information back to the stationary device implementing the mobile suite 130.

As shown, the digital twin mobile suite 130 currently displays an interface screen for providing a user access to and interaction with a building scanning application. This building scanning application may be used for various purposes such as for capturing a floorplan of a building for conversion to a new digital twin or for updating an existing digital twin. For example, by scanning the walls of a room, the specific geometry of that room (or other descriptive information) can be captured and modeled in the digital twin. As such, the scanning application may also be used as a digital twin creator, to capture the structure of an existing building 110 in the digital twin 120, so that the digital twin 120 can be used by other applications (including those provided by the digital twin mobile suite 130 or by other external applications such as a controller that autonomously controls the HVAC or other controllable system of the environment 110).

The digital twin mobile suite's 130 current interface scene includes a live view 140 of the user's surroundings. In particular, a camera of the device may capture a live image and the mobile suite may display this live image on a screen of the device. Thus, as the user moves the device in space, the portion of the surrounding environment displayed in the live view 140 may change to show whatever the camera is currently capturing. Various enhancements to the live view 140 may be implemented such as augmented reality elements (e.g., grid lines overlaid on the detected geometry, coloring to illustrate already-captured geometry, etc.). The live view 140 may also enable user inputs such as, for example, allowing a user to virtually “mark” a wall, door, window or other feature to help instruct the scanning application how to interpret the image and other data being gathered for creating or modifying the digital twin 120.

As shown, the live image 140 currently captures an image of a sensor device 140, which may be a device that the mobile suite 130 can commission. As used herein, the term “commission” will be understood to encompass a collection of activities encompassing any subset of activating, testing the operation of, and verifying the proper installation of a device. The displayed scanning application may switch to a commissioning application to commission the sensor device upon, e.g., manual user request or automatically based on proximity to the device to be commissioned.

The digital twin mobile suite's 130 current interface scene also includes a number of interface elements for enabling user interaction or providing additional information to the user. A back button may allow the user to indicate that the mobile suite 130 should return to a previous interface scene (e.g., a scene from which the current view of the scanning application was launched). A menu button 155 may enable the user to indicate that a menu of additional buttons (not shown) should be expanded for additional selection and activation of tools associated with the scanning application. For example, the menu accessible via the button 155 may provide tools for beginning a scan of a new room, beginning a scan of a new floor, switching to a commissioning or other application, adding or labeling objects to the digital twin at the current location (e.g., sensor devices 145, controllers, or even generic objects that the user can tag with a captured image or other descriptive information).

A minimap 160 may also be overlaid on the live view 140 for guiding the user in completing a scan. The minimap 160 includes a view cone 162 for indicating a user's (or, more accurately, the device's) current position and orientation relative to a currently-scanned floorplan 164. In some embodiments, the view cone 162 may be stationary, always pointing “up” relative to the interface as the in-progress floorplan 164 rotates to indicate orientation. In other embodiments, the view cone 162 may rotate to display user orientation (e.g., relative to north) while the in progress floorplan does not rotate and merely pans within the minimap window to track the user as they walk through the environment. Various other arrangements will be apparent. The in-progress minimap 164 may display a current state of the room as captured by the scanning application or as is currently committed in the digital twin 120. As shown, the in-progress minimap shows that only two walls, perpendicular to each other, have been partially captured. As more of the current room is scanned, the in-progress minimap may update to show more of the scanned perimeter of the room until the full perimeter has been captured. In some embodiments, other previously-scanned (or captured in the digital twin 120 via other means) rooms may be also shown as part of the in-progress minimap 164.

It should be apparent from the foregoing description that various example embodiments of the invention may be implemented in hardware or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a mobile device, a tablet, a server, or other computing device. Thus, a machine-readable storage medium may include read-only memory (ROM), random-access memory (RAM), magnetic disk storage media, optical storage media, flash-memory devices, and similar storage media.

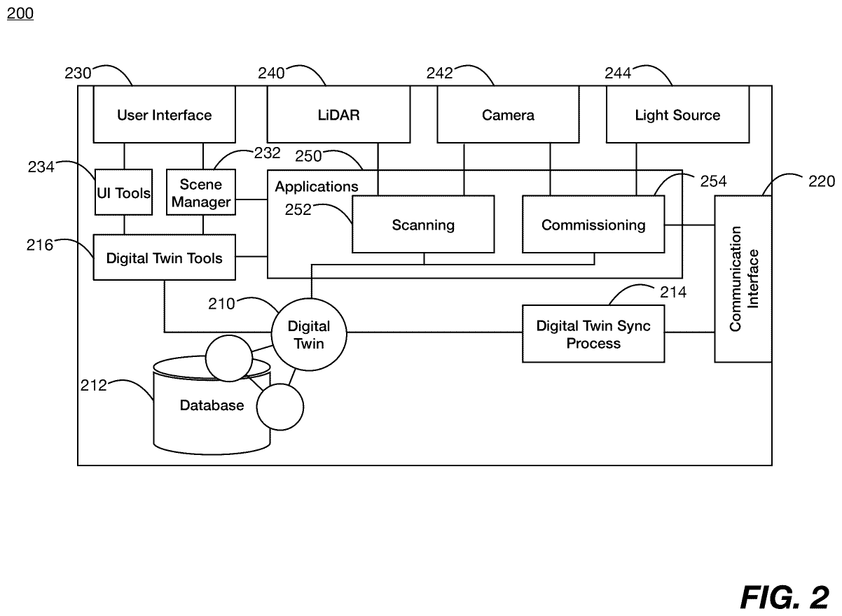

FIG. 2 illustrates an example device for implementing a digital twin mobile suite 200. The digital twin mobile device 200 may correspond to the device that provides digital twin mobile suite 130 and, as such, may provide a user with access to one or more applications for interacting with a digital twin. According to various embodiments, the digital twin mobile device 200 is a mobile device such as a mobile phone or a tablet.

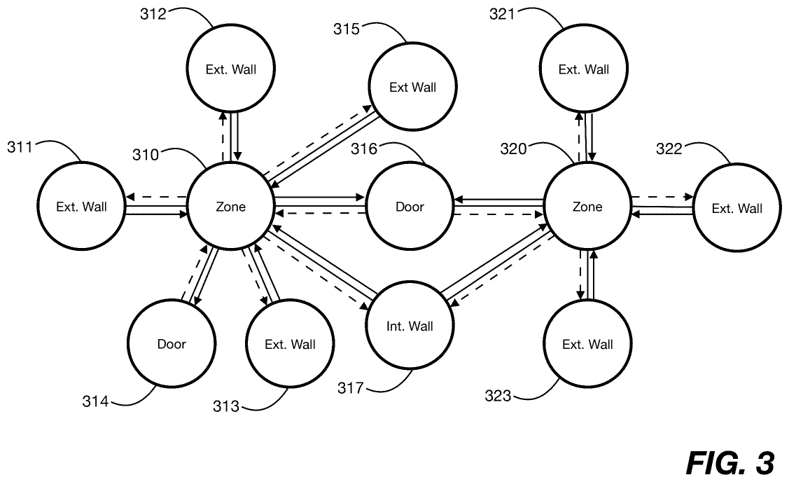

The digital twin application device 200 includes a digital twin 210, which may be stored in a database 212. The digital twin 210 may correspond to the digital twin 120 or a portion thereof (e.g., those portions relevant to the applications provided by the digital twin mobile device 200). The digital twin 210 may be used to drive or otherwise inform many of the applications provided by the digital twin mobile device 200. A digital twin 210 may be any data structure that models a real-life object, device, system, or other entity. Examples of a digital twin 210 useful for various embodiments will be described in greater detail below with reference to FIG. 3. While various embodiments will be described with reference to a particular set of heterogeneous and omnidirectional neural network digital twins, it will be apparent that the various techniques and embodiments described herein may be adapted to other types of digital twins. In some embodiments, additional systems, entities, devices, processes, or objects may be modeled and included as part of the digital twin 210.

In some embodiments, the digital twin 210 may be created and used entirely locally to the digital twin mobile device 200. In others, the digital twin 210 may be made available to or from other devices via a communication interface 220. The communication interface 220 may include virtually any hardware for enabling connections with other devices, such as an Ethernet network interface card (NIC), WiFi NIC, Bluetooth, or USB connection.

A digital twin sync process 214 may communicate with one or more other devices via the communication interface 220 to maintain the state of the digital twin 210. For example, where the digital twin mobile device 200 creates or modifies the digital twin 210 to be used by other devices, the digital twin sync process 214 may send the digital twin 210 or updates thereto to such other devices as the user changes the digital twin 210. Similarly, where the digital twin mobile device 200 uses a digital twin 210 created or modified by another device, the digital twin sync process 214 may request or otherwise receive the digital twin 210 or updates thereto from the other devices via the communication interface 220, and commit such received data to the database 212 for use by the other components of the digital twin mobile device 200. In some embodiments, both of these scenarios simultaneously exist as multiple devices collaborate on creating, modifying, and using the digital twin 210 across various applications. As such, the digital twin sync process 214 (and similar processes running on such other devices) may be responsible for ensuring that each device participating in such collaboration maintains a current copy of the digital twin, as presently modified by all other such devices. In various embodiments, this synchronization is accomplished via a pub/sub approach, wherein the digital twin sync process 214 subscribes to updates to the digital twin 210 and publishes its own updates to be received by similarly-subscribed devices. Such a pub/sub approach may be supported by a centralized process, such as a process running on a central server or central cloud instance.

A set of digital twin tools 216 may provide various libraries for enabling or enhancing other mobile device 200 component interactions with the digital twin 210. As an example, the digital twin tools may include an introspection library for introspecting the digital twin. This introspection may include simply reading or writing values from the nodes of the digital twin 210, executing sophisticated queries against the digital twin 210 to read or write to values (or groupings thereof) matching the query, or performing transformations of data that is read or written to nodes of the digital twin 210 (e.g., translating between Fahrenheit and Celsius).

The digital twin tools 216 may also provide libraries for leveraging the digital twin 210 for problem solving. In particular, where the digital twin 210 is constructed to contain continuous parameters that can be used by differentiable maps, the digital twin tools 216 may provide libraries for constructing cost functions from the digital twin 210 for training or optimization tasks in terms of such cost function using one or more gradient-descent-based algorithms. As another example, the digital twin tools 216 may enable construction of a cost function that relates orientations or other positional information of various walls (as represented by nodes in the digital twin 210) to a measure of how much the walls deviate from being perpendicular to each other. Optimization of the cost function by tuning the positional information of the walls may then enable fine tuning floorplans (as captured in the digital twin 210) to match a user's expectations of square rooms. In this way, the digital twin tools 216 may provide a generalizable problem-solving kit for advanced modification and inference drawing from the digital twin 210. Various additional libraries for inclusion in the digital twin tools 216 for enhancing device 200 component interactions with the digital twin 210 will be apparent.

To enable user interaction with the digital twin 210, the digital twin mobile device 200 includes a user interface 230. For example, the user interface 230 may include a display, a touchscreen, a keyboard, a mouse, or any device capable of performing input or output functions for a user. In some embodiments, the user interface 230 may instead or additionally allow a user to use another device for such input or output functions, such as connecting a separate tablet, mobile phone, or other device for interacting with the digital twin mobile device 200. In such embodiments one or more of the lidar 240, camera 242, or light source 244 may instead be disposed on such external device connected via the user interface 230. In some embodiments, the user interface 230 includes a web server that serves interfaces to a remote user's personal device (e.g., via the communications interface). Thus, in some embodiments, the applications provided by the digital twin mobile device 200 may be provided as a web-based software-as-a-service (SaaS) offering.

The user interface 230 may rely on multiple additional components for constructing one or more graphical user interfaces for interacting with the digital twin 210. A scene manager 232 may store definitions of the various interface scenes that may be offered to the user. As used herein, an interface scene will be understood to encompass a collection of panels, tools, and other GUI elements for providing a user with a particular application (or set of applications). For example, separate sets interface scenes may be defined for enabling interaction with a scanning application and commissioning application. It will be understood that various customizations and alternate views may be provided to a particular interface scene without constituting an entirely new interface scene. For example, panels may be rearranged, tools may be swapped in and out, and information displayed may change during operation without fundamentally changing the overall application provided to the user via that interface scene.

The UI tool library 234 stores definitions of the various tools that may be made available to the user via the user interface 230 and the various interface scenes (e.g., by way of a selectable interface button). These tool definitions in the UI tool library 234 may include software defining manners of interaction that add to, remove from, or modify aspects of the digital twin. As such, tools may include a user-facing component that enables interaction with aspects of the user interface scene, and a digital twin-facing component that captures the context of the user's interactions and instructs the digital twin tools 216 to make appropriate modifications to the digital twin 210.

The digital twin mobile device 200 includes both a LiDAR device 240 and a camera 242 for capturing information about the surrounding environment. The camera 242 may be capable of capturing image information such as still images or video. The LiDAR device 240 is a light detection and ranging device for gathering depth information about the environment. As such, the LiDAR device 240 may emit light (e.g., infrared light) and measure the time it takes for the reflection to be received at a sensor. This time may then be converted to a distance (i.e., a depth), indicating how far away a surface is from the device 200. It will be apparent that other technologies may be used for gathering depth information about the environment including applications of radar, sonar, or even advanced image processing (e.g., recognizing shadows in images or relative movements of objects in video captured by the camera 242). The digital twin mobile device 200 also includes a light source 244, such as a photodiode used for illuminating a subject for the camera 242 to capture or for operating by the user as a flashlight. The light source 244 may be controllable by other components of the device 200 and may offer configurable levels of illumination.

To use the various other components of the device to provide the functionalities described herein, the device 200 may include one or more applications 250. In some embodiments, the applications 250 may be each be provided as separate “apps” downloadable from a marketplace and separately launchable by the user. In other embodiments, the applications 250 may instead be libraries of a single “app” or other collected suites of software. For example, the software elements 210-216, 230-234, 250-254 may be included as a single app.

A scanning application 252 may enable the user to scan an environment such that its structure is captured and converted into a digital twin 210 (or portion thereof or update thereto). The scanning application 252 may utilize the LiDAR and positional information (e.g., GPS information provided by the communication interface or positional information provided by an accelerometer, not shown) to generate a 3D surface representative of the device's 200 surroundings. The scanning application 252 then further digests this 3D surface information into simplified descriptions of the surrounding environment. For example, the scanning application 252 may identify substantially planar surfaces in the 3D surface information and designate these as walls having particular location, dimensions, and other information. These descriptions may then be in a form suitable for commitment by the scanning application 252 to the digital twin 210 (e.g., using one or more libraries provided by the digital twin tools 216). In a similar manner, the scanning application 252 may include additional functionality for extracting door, window, object, and other data from the 3D scan data produced by the LiDAR device 240.

The scanning application 252 functionality may be supplemented by user interaction, e.g., via the user interface 230. For example, where a current scene (as managed by the scene manager 232) specifies that a live image and minimap is to be provided to the user, the scanning application 252 may provide image data from the camera 242 and a minimap rendered from the current scan (e.g., as may be already partially captured in the digital twin) to the scene manager 232 for presentation via the user interface 230. The scanning application 252 may also identify one or more UI tools 234 to present to the user for enabling interaction with the scanning process. For example, a UI tool 234 may enable a user to virtually “draw” on the live image to identify a wall surface or the boundaries of a window or door. Such information may further inform the operation of the scanning application 252 in interpreting the 3D scan data from the LiDAR device 240. As another example, a UI tool 234 may enable a user to add a virtual tag to the environment. This virtual tag may be stored with positional information (e.g., the current position of the device or the position targeted by the user in the 3D scan data), image information (e.g., as captured from the camera 242), textual information (e.g., as entered by the user), or other information for storage in the digital twin 210 and, thus, later use by a downstream application.

The commissioning application 254 may enable the user to commission devices installed in the environment. In particular, the commissioning application 254 may use descriptions of the devices installed in the environment stored in the digital twin 210 to identify what devices exist to be commissioned, where those devices are located in the environment, how to communicate with those devices, what commissioning procedures are to be performed (e.g., what tests are relevant and what the passing criteria are), etc. To begin commissioning processes, in some embodiments, the device first needs to be near the receiving device. To guide the user in achieving sufficient proximity, the commissioning application 254 may instruct the scene manager 232 to display various feedback such as textual instructions or a live image captured by the camera 242 with augmented reality or other UI features to direct the user appropriately. When ready to begin a commissioning procedure, the commissioning application 254 may initiate communication with the receiving device via the communication interface (e.g., using the Bluetooth protocol). In some embodiments, such as those where the device is initially expected to be powered off or otherwise unable to communicated via the communications interface 220, the commissioning application 254 may first cause the device to be powered on by instructing the user to take manual action or by controlling the light source 244 to cause the device to turn on. For example, in some embodiments, a device may include a photovoltaic sensor configured to power the device on in response to one or more pulses of light producible by the light source 244. In some embodiments, the commissioning application 254 may also encode a message for passage via the light source 244 and delivery to the device such as, for example, a security key to be used in establishing communication via the communication interface 220. Once communication is established, the commissioning application 254 may pass messages back and forth with the device (and potentially other devices, such as a controller) to test and verify proper installation. If there is a problem, the commissioning application 254 may display a message indicating such to the user via the scene manager 232 and user interface 230.

FIG. 3 illustrates an example digital twin 300 for construction by or use in various embodiments. The digital twin 300 may correspond, for example, to digital twin 120 or digital twin 210. As shown, the digital twin 300 includes a number of nodes 310-323 connected to each other via edges. As such, the digital twin 300 may be arranged as a graph, such as a neural network. In various alternative embodiments, other arrangements may be used. Further, while the digital twin 300 may reside in storage as a graph type data structure, it will be understood that various alternative data structures may be used for the storage of a digital twin 300 as described herein. The nodes 310-323 may correspond to various aspects of a building structure such as zones, walls, and doors. The edges between the nodes 310-323 may, then, represent relationships between the aspects represented by the nodes 310-323 such as, for example, adjacency for the purposes of heat transfer.

As shown, the digital twin 300 includes two nodes 310, 320 representing zones. A first zone node 310 is connected to four exterior wall nodes 311, 312, 313, 315; two door nodes 314, 316; and an interior wall node 317. A second zone node 320 is connected to three exterior wall nodes 321, 322, 323; a door node 316; and an interior wall node 317. The interior wall node 317 and door node 316 are connected to both zone nodes 310, 320, indicating that the corresponding structures divide the two zones. This digital twin 300 may thus correspond to a two-room structure.

It will be apparent that the example digital twin 300 may be, in some respects, a simplification. For example, the digital twin 300 may include additional nodes representing other aspects such as additional zones, windows, ceilings, foundations, roofs, points of interest, or external information such as the weather or a forecast thereof. It will also be apparent that in various embodiments the digital twin 300 may encompass alternative or additional systems such as controllable systems of equipment (e.g., HVAC systems).

According to various embodiments, the digital twin 300 is a heterogenous neural network. Typical neural networks are formed of multiple layers of neurons interconnected to each other, each starting with the same activation function. Through training, each neuron's activation function is weighted with learned coefficients such that, in concert, the neurons cooperate to perform a function. The example digital twin 300, on the other hand, may include a set of activation functions (shown as solid arrows) that are, even before any training or learning, differentiated from each other, i.e., heterogenous. In various embodiments, the activation functions may be assigned to the nodes 310-323 based on domain knowledge related to the system being modeled. For example, the activation functions may include appropriate heat transfer functions for simulating the propagation of heat through a physical environment (such as function describing the radiation of heat from or through a wall of particular material and dimensions to a zone of particular dimensions). As another example, activation functions may include functions for modeling the operation of an HVAC system at a mathematical level (e.g., modeling the flow of fluid through a hydronic heating system and the fluid's gathering and subsequent dissipation of heat energy). Such functions may be referred to as “behaviors” assigned to the nodes 310-323. In some embodiments, each of the activation functions may in fact include multiple separate functions; such an implementation may be useful when more than one aspect of a system may be modeled from node-to-node. For example, each of the activation functions may include a first activation function for modeling heat propagation and a second activation function for modeling humidity propagation. In some embodiments, these diverse activation functions along a single edge may be defined to act in opposite directions. For example, a heat propagation function may be defined from node 310 to node 311, while a humidity propagation function may be defined from node 311 to node 310. In some embodiments, the diversity of activation functions may differ from edge to edge. For example, one activation function may include only a heat propagation function, another activation function may include only a humidity propagation function, and yet another activation function may include both a heat propagation function and a humidity propagation function.

According to various embodiments, the digital twin 300 is an omnidirectional neural network. Typical neural networks are unidirectional-they include an input layer of neurons that activate one or more hidden layers of neurons, which then activate an output layer of neurons. In use, typical neural networks use a feed-forward algorithm where information only flows from input to output, and not in any other direction. Even in deep neural networks, where other paths including cycles may be used (as in a recurrent neural network), the paths through the neural network are defined and limited. The example digital twin 300, on the other hand, may include activation functions along both directions of each edge: the previously discussed “forward” activation functions (shown as solid arrows) as well as a set of “backward” activation functions (shown as dashed arrows).

In some embodiments, at least some of the backward activation functions may be defined in the same way as described for the forward activation functions-based on domain knowledge. For example, while physics-based functions can be used to model heat transfer from a surface (e.g., a wall) to a fluid volume (e.g., an HVAC zone), similar physics-based functions may be used to model heat transfer from the fluid volume to the surface. In some embodiments, some or all of the derivates of the activation functions are derived using automatic differentiation techniques. Specifically, according to some embodiments, reverse mode automatic differentiation is used to compute the partial derivative of an activation function. This partial derivative may then be used to traverse the graph in the opposite direction of that forward activation function. Thus, for example, while the forward activation function from node 311 to node 310 may be defined based on domain knowledge and allow traversal (e.g., state propagation as part of a simulation) from node 311 to node 310 in linear space, the reverse activation function may be defined as a partial derivative computed from that forward activation function and may allow traversal from node 310 to 311 in the derivative space. In this manner, traversal from any one node to any other node is enabled—for example, the graph may be traversed (e.g. state may be propagated) from node 312 to node 313, first through a forward activation function, through node 310, then through a backward activation function. By forming the digital twin as an omnidirectional neural network, its utility is greatly expanded; rather than being tuned for one particular task, it can be traversed in any direction to simulate different system behaviors of interest and may be “asked” many different questions.

According to various embodiments, the digital twin is an ontologically labeled neural network. In typical neural networks, individual neurons do not represent anything in particular; they simply form the mathematical sequence of functions that will be used (after training) to answer a particular question. Further, while in deep neural networks, neurons are grouped together to provide higher functionality (e.g. recurrent neural networks and convolutional neural networks), these groupings do not represent anything other than the specific functions they perform; i.e., they remain simply a sequence of operations to be performed.

The example digital twin 300, on the other hand, may ascribe meaning to each of the nodes 310-323 and edges therebetween by way of an ontology. For example, the ontology may define each of the concepts relevant to a particular system being modeled by the digital twin 300 such that each node or connection can be labeled according to its meaning, purpose, or role in the system. In some embodiments, the ontology may be specific to the application (e.g., including specific entries for each of the various HVAC equipment, sensors, and building structures to be modeled), while in others, the ontology may be generalized in some respects. For example, rather than defining specific equipment, the ontology may define generalized “actors” (e.g., the ontology may define producer, consumer, transformer, and other actors for ascribing to nodes) that operate on “quanta” (e.g., the ontology may define fluid, thermal, mechanical, and other quanta for propagation through the model) passing through the system. Additional aspects of the ontology may allow for definition of behaviors and properties for the actors and quanta that serve to account for the relevant specifics of the object or entity being modeled. For example, through the assignment of behaviors and properties, the functional difference between one “transport” actor and another “transport” actor can be captured.

The above techniques, alone or in combination, may enable a fully-featured and robust digital twin 300, suitable for many purposes including system simulation and control path finding. The digital twin 300 may be computable and trainable like a neural network, queryable like a database, introspectable like a semantic graph, and callable like an API.

As described above, the digital twin 300 may be traversed in any direction by application of activation functions along each edge. Thus, just like a typical feedforward neural network, information can be propagated from input node(s) to output node(s). The difference is that the input and output nodes may be specifically selected on the digital twin 300 based on the question being asked, and may differ from question to question. In some embodiments, the computation may occur iteratively over a sequence of timesteps to simulate over a period of time. For example, the digital twin 300 and activation functions may be set at a particular timestep (e.g., one second), such that each propagation of state simulates the changes that occur over that period of time. Thus, to simulate longer period of time or a point in time further in the future (e.g., one minute), the same computation may be performed repeatedly until a number of timesteps equaling the period of time have been simulated (e.g., 60 one second time steps to simulate a full minute). The relevant state over time may be captured after each iteration to produce a value curve (e.g., the predicted temperature curve at node 310 over the course of a minute) or a single value may be read after the iteration is complete (e.g., the predicted temperature at node 310 after a minute has passed). The digital twin 300 may also be inferenceable by, for example, attaching additional nodes at particular locations such that they obtain information during computation that can then be read as output (or as an intermediate value as described below).

While the forward activation functions may be initially set based on domain knowledge, in some embodiments training data along with a training algorithm may be used to further tune the forward activation functions or the backward activation functions to better model the real world systems represented (e.g., to account for unanticipated deviations from the plans such as gaps in venting or variance in equipment efficiency) or adapt to changes in the real world system over time (e.g., to account for equipment degradation, replacement of equipment, remodeling, opening a window, etc.).

Training may occur before active deployment of the digital twin 300 (e.g., in a lab setting based on a generic training data set) or as a learning process when the digital twin 300 has been deployed for the system it will model. To create training data for active-deployment learning, a controller device (not shown) may observe the data made available from the real-world system being modeled (e.g., as may be provided by a sensor system deployed in the environment 110) and log this information as a ground truth for use in training examples. To train the digital twin 300, that controller may use any of various optimization or supervised learning techniques, such as a gradient descent algorithm that tunes coefficients associated with the forward activation functions or the backward activation functions. The training may occur from time to time, on a scheduled basis, after gathering of a set of new training data of a particular size, in response to determining that one or more nodes or the entire system is not performing adequately (e.g., an error associated with one or more nodes 310-323 passed a threshold or passes that threshold for a particular duration of time), in response to manual request from a user, or based on any other trigger. In this way, the digital twin 300 may be adapted to better adapt its operation to the real world operation of the systems it models, both initially and over the lifetime of its deployment, by tacking itself to the observed operation of those systems.

The digital twin 300 may be introspectable. That is, the state, behaviors, and properties of the 310-323 may be read by another program or a user. This functionality is facilitated by association of each node 310-323 to an aspect of the system being modeled. Unlike typical neural networks where, due to the fact that neurons don't represent anything particularly the internal values are largely meaningless (or perhaps exceedingly difficult or impossible to ascribe human meaning), the internal values of the nodes 310-323 can easily be interpreted. If an internal “temperature” property is read from node 310, it can be interpreted as the anticipated temperature of the system aspect associated with that node 310.

Through attachment of a semantic ontology, as described above, the introspectability can be extended to make the digital twin 300 queryable. That is, ontology can be used as a query language usable to specify what information is desired to be read from the digital twin 300. For example, a query may be constructed to “read all temperatures from zones having an area larger than 200 square feet and an occupancy of at least one.” A process for querying the digital twin 300 may then be able to locate all nodes 310-323 representing zones that have properties matching the area and occupancy criteria, and then read out the temperature properties of each. The digital twin 300 may then additionally be callable like an API through such processes. With the ability to query and inference, canned transactions can be generated and made available to other processes that aren't designed to be familiar with the inner workings of the digital twin 300. For example, an “average zone temperature” API function could be defined and made available for other elements of the controller or even external devices to make use of. In some embodiments, further transformation of the data could be baked into such canned functions. For example, in some embodiments, the digital twin 300 itself may not itself keep track of a “comfort” value, which may defined using various approaches such as the Fanger thermal comfort model. Instead, e.g., a “zone comfort” API function may be defined that extracts the relevant properties (such as temperature and humidity) from a specified zone node, computes the comfort according to the desired equation, and provides the response to the calling process or entity.

It will be appreciated that the digital twin 300 is merely an example of a possible embodiment and that many variations may be employed. In some embodiments, the number and arrangements of the nodes 310-323 and edges therebetween may be different, either based on the device implementation or based on the system being modeled. For example, a controller deployed in one building may have a digital twin 300 organized one way to reflect that building and its systems while a controller deployed in a different building may have a digital twin 300 organized in an entirely different way because the building and its systems are different from the first building and therefore dictate a different model. Further, various embodiments of the techniques described herein may use alternative types of digital twins. For example, in some embodiments, the digital twin 300 may not be organized as a neural network and may, instead, be arranged as another type of model for one or more components of the environment 110. In some such embodiments, the digital twin 300 may be a database or other data structure that simply stores descriptions of the system aspects, environmental features, or devices being modeled, such that other software has access to data representative of the real world objects and entities, or their respective arrangements, as the software performs its functions.

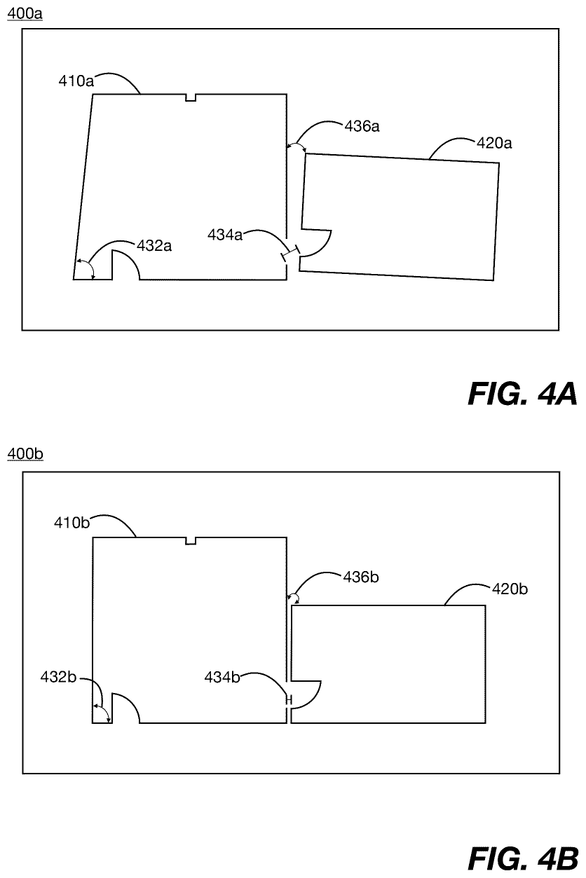

FIG. 4A illustrates an example interface 400a illustrating an uncorrected floorplan. The interface 400a may be shown by the scene manager 232 as part of an interface for the scanning application 252. For example, the interface 400a may be displayed as an in-progress scan in a minimap such as minimap 160 or may be part of another view that illustrates a floorplan that has been captured. As such, the interface 400a may constitute a rendering of a portion of a digital twin 120, 210, 300 describing two rooms of a building. For example, the two-room digital twin 300 may be descriptive of the same structure represented in the interface 400a.

As shown, the interface 400a illustrates the perimeters of two rooms 410a, 420a. These rooms 410a, 420a may correspond to the zone nodes 310, 320 respectively. In various embodiments, the information captured in the digital twin 300 may not be entirely accurate to the real world structure or may otherwise not conform to various user expectations. Such inaccuracies may be imparted due to user error, imperfection or errors in the scanning application 252, or any other source. For example, an angle 432a between two walls of the first room 410a may not be a right angle. This may be considered incorrect either because the real world room corner forms a right angle or because, while the real world room corner is not precisely a right angle, the user will expect a right angle. This inaccuracy may be indicative of incorrect data stored in the digital twin. For example, vertices or orientation properties stored in the exterior wall node 311 may be incorrect.

As another example of an imperfection, the two rooms 410a, 420a may be positioned or oriented incorrectly with respect to each other. This may be indicated by the angle 436a between the adjacent walls being non-parallel. Also, the distance 434a between the walls may be more than an expected amount (e.g., the typical substantially 4.5 inch interior wall depth for most constructions).

Accordingly to the foregoing, there exists a need for a method for correcting inaccuracies in a floorplan captured by scanning a room or represented by a digital twin. According to various techniques presented herein, the storage of a floorplan as a digital twin is leveraged to provide a powerful method for performing such correction. In particular, by leveraging a neural network style digital twin, machine learning techniques and optimizations can be leveraged to perform corrections that match user expectations while maintaining other properties relating to the structure that need not be corrected. Further, the constraint based solving and optimizations may be used for other advanced digital twin modifications or generative design. Various other technical benefits will be apparent in view of the teachings and techniques presented herein.

FIG. 4B illustrates an example interface 400b illustrating a corrected floorplan. This interface 400b may be shown by the scene manager 232 as part of an interface for the scanning application 252 after one or more corrections have been performed. For example, the interface 400b may be displayed as an in-progress scan in a minimap such as minimap 160 or may be part of another view that illustrates a floorplan that has been captured. As such, the interface 400b may constitute a rendering of a portion of a digital twin 120, 210, 300 describing two rooms of a building. For example, the interface 400b may render a floorplan from the digital twin 300 after performance of one or more correction optimizations, as described herein.

As shown, the previously non-right angle 432a has been corrected to be a right angle 432b. For example, the correction process may have moved the vertices or changed the orientation (depending on how this information happens to be expressed) in the wall node 311. Further, the relative positions and orientations of the two rooms 410b, 420b have been corrected such that the angle 436b therebetween is parallel and the distance 434b therebetween is reduced to the expected intra-wall depth. To effect this change, the correction process may have moved the vertices or positions and orientations of the wall nodes 321, 322, 323 to achieve alignment with the first room 410b while preserving other structural details such as wall dimensions and the pre-existing right angles therebetween.

According to various embodiments, the correction process creates a cost function from the digital twin 300 that can be optimized to tune the parameters of the walls and thereby arrive at a corrected digital twin and floorplan rendered therefrom, as described above. Such a cost function may include penalty factors for various inaccuracies (e.g., degrees off right angle between walls intended to be perpendicular, degrees off parallel between adjacent walls, etc.) for various inputs (e.g., wall vertices or wall positions and orientations). By optimizing such a cost function (e.g., by performing gradient descent to find a global or at least better local minimum for the weighted sum of all penalties), the parameters of the digital twin can be tuned to satisfy the imposed constraints and thereby correct the digital twin 300. In certain embodiments, the cost function terms can be calculated for each specific aspect requiring correction. For instance, the system may evaluate each adjacent wall angle, generate a penalty term based on its deviation, and incorporate this term into the overall cost function. This approach allows all inaccuracies, including those related to angle deviations, to be corrected through a single optimization process.

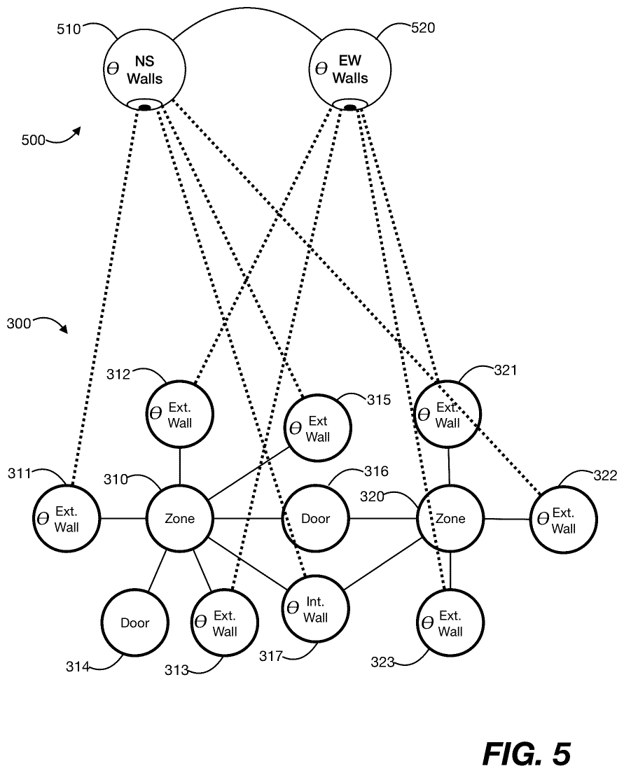

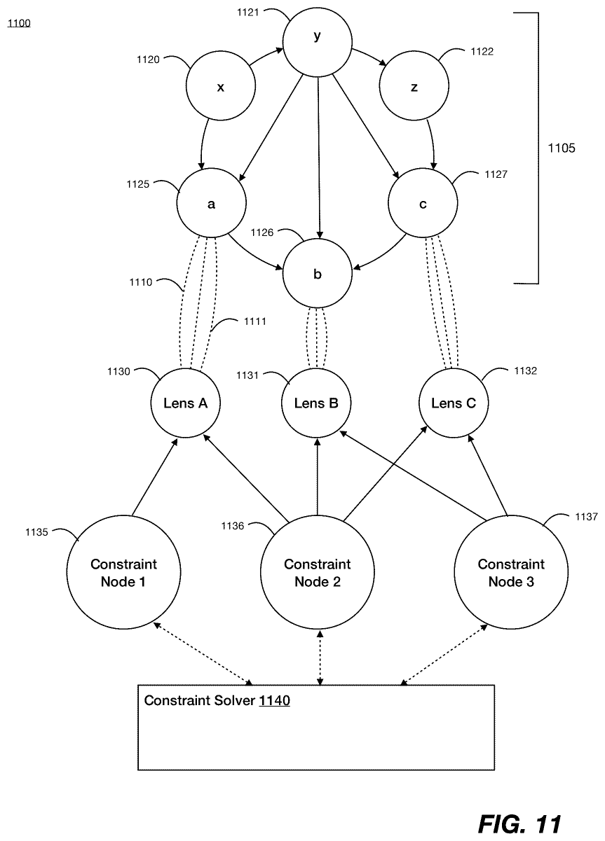

FIG. 5 illustrates an example hypergraph 500 of a digital twin 300 for creating a cost function. By creating a hypergraph 500 of one or more nodes derived from the digital twin 300, a cost function may be more easily constructed to enable satisfaction of multiple constraints (e.g., correcting multiple potential inaccuracies) as part of a single optimization. As shown, the hypergraph includes two hypernodes: a first hypernode 510 for capturing the orientations of all of the roughly north-to-south wall nodes 311, 315, 317, 322 and a second hypernode 520 for capturing the orientations of all the roughly east-to-west wall nodes 312, 313, 321, 323. With such an arrangement, a cost function can be constructed in terms of the properties of these hypernodes 510, 520, rather than the individual digital twin nodes 311, 312, 313, 315, 317, 321, 322, 323 on a pairwise basis. An another exemplary embodiment of hypernodes is shown with relation to FIG. 11 and the surrounding text.

In various embodiments, the hypernodes 510, 520 may be references into particular properties of the digital twin 300 or to specific memory locations associated with the digital twin 300. For example, in implementations utilizing the Swift programming language, each hypernode 510, 520 includes one or more keypaths, as defined by that language. As will be understood, keypaths are a type of reference that enables getting and setting the properties of a particular object or associated memory location. In some such embodiments, the hypernodes 510, 520 are broadcast keypaths that store references to multiple properties. To establish such a hypernode, a query may first be executed to identify which properties or associated memory locations should be associated with the broadcast keypath. Various query languages may be used to execute such a query against the digital twin 300 such as, for example, GraphQL or a derivative thereof. After executing the query and identifying the set of nodes 310-323 matching the query, the hypernode 510, 520 may store a collection of keypaths for the structural properties of the identified nodes 310-323. Thereafter, get, set, or other operations performed with respect to a hypernode 510, 520 may be performed with respect to each of the keypaths associated with that hypernode 510, 520.

As an example, the first hypernode 510 is associated with substantially north and south facing walls. The hypernode 510 may have been established using a query that selects all nodes 310-323 in the digital twin representing walls, and having a property indicating that the modeled wall is facing roughly north or south. For example, where the wall nodes 311-313, 315, 317, 321-323 store an orientation value between 0 and 359 degrees (with 0 representing exactly east, 90 exactly north, 180 exactly west, and 270 exactly south), the query may indicate that the orientation property of all nodes having a type of “wall” and an orientation of 85-95 or 265-275 should be selected, thus selecting all walls that are 5 degrees or less off from facing exactly north or south. After running this query and, in this instance, identifying nodes 311, 315, 317, and 322, the hypernode 510 stores a collection of keypaths that reference the properties of these four nodes 311, 315, 317, and 322, respectively. Thereafter, when the orientation “property” of the hypernode 510 is read, a collection of four orientation properties from these four nodes 311, 315, 317, 322 may be returned. Similarly, then the orientation “property” of the hypernode 510 is set, the values of these four orientation properties from these four nodes 311, 315, 317, 322 may be set to that value.

As another example, the second hypernode 520 is associated with substantially east and west facing walls. In our illustrative example, the hypernode 510 may have been established using a query that selects all nodes 310-323 in the digital twin representing walls and having a property indicating that the modeled wall runs roughly east and west. For example, the query may indicate that the orientation property of all nodes having a type of “wall” and an orientation of 355-5 or 175-185 should be selected, thus selecting all walls that are 5 degrees or less off from exactly east or west. After running this query and identifying nodes 312, 313, 321, and 323, the hypernode 520 stores a collection of keypaths that reference the orientation properties of these four nodes 312, 313, 321, 323, respectively. Thereafter, when the orientation “property” of the hypernode 520 is read, a collection of four orientation properties from these four nodes 312, 313, 321, 323 may be returned. Similarly, when the orientation “property” of the hypernode 520 is set, the values of these four orientation properties from these four nodes 312, 313, 321, 323 may be set to that value.

Having established the hypergraph 500, the system can construct a cost-function in terms of the hypernodes 510, 520, either alone or in combination with digital twin nodes 310-323. For example, for the problem of correcting angles between intended perpendicular walls, a cost function can be constructed with a cost expressed as “|90−θdiff(NS, EW)|,” i.e., the magnitude by which the angles between the north or south facing walls and east or west facing walls deviate from 90 degrees. On evaluation, the system may expand this cost function to be evaluated against the properties referenced in the keypaths for the two hypernodes 510, 520. Various methods for this expansion will be apparent such as comparing each keypath-referenced property in the first hypernode 510 to each keypath-referenced property in the second hypernode 520 (for 16 total comparisons); or comparing only those keypath-referenced property pairs from adjacent walls (for 8 total comparisons).

Various alternatives and additional enhancements for implementation in the hypernodes 510, 520 will be apparent. For example, in some embodiments, a hypernode 510, 520 may store keypaths to objects higher up in a hierarchy than individual properties. For example, the keypaths stored in hypernode 510 may reference the wall nodes 311, 315, 317, 322 themselves, rather than the orientation properties thereof. The orientation and other properties may then be accessed as needed by name (e.g., by accessing NSWalls.orientation or NSWalls.position). In some embodiments, the hypernodes 510, 520 may implement one or more transformations such that additional or alternative expressions of data is available for hypergraph 500 purposes. Get, set, and other operations performed via the hypernodes 510, 520 may thus be passed through this transformation (or its inverse, as appropriate) to provide this alternative way of working with the data. As an example, a transformation may provide a new property entirely; for example, a transformation function may access heat, humidity, and other properties stored in the digital twin 300 and apply a function that generates a comfort value, which may be useful for other applications. Various additional uses for transformations will be apparent.

In constructing the cost function, other constraints imposed by the digital twin may also be taken into account or preserved. For example, where the endpoints of the walls are also separately stored in the wall nodes 311-313, 315, 317, 321-323, the cost function may also include a term penalizing any changes that result in two adjacent walls not meeting at a common endpoint. Alternatively or additionally, where properties are derived from those being changed, those properties may be rederived after completion of the optimization process or at each step in optimization. For example, in some embodiments, the positions and orientations may be used to identify their point of intersection, and then set the appropriate endpoint accordingly (if endpoints are indeed to be separately stored in the wall nodes 311-313, 315, 317, 321-323). In some embodiments, the cost function may additionally be provided with a term that penalizes all changes to the independent variables, generally, such that the optimization process is discouraged from modifying the digital twin too far from the initial scan data.

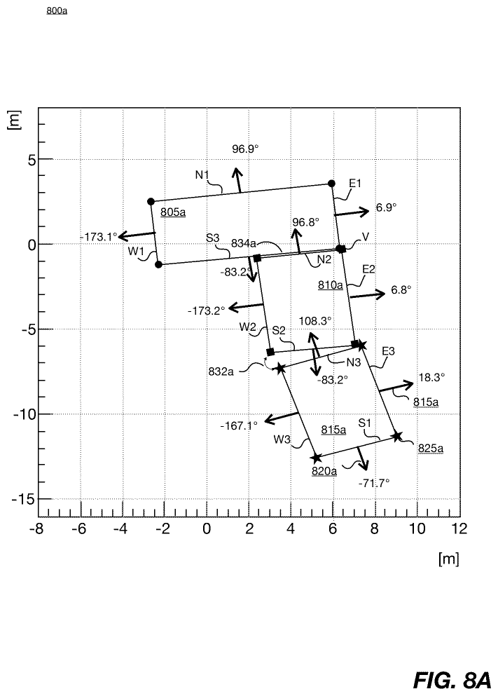

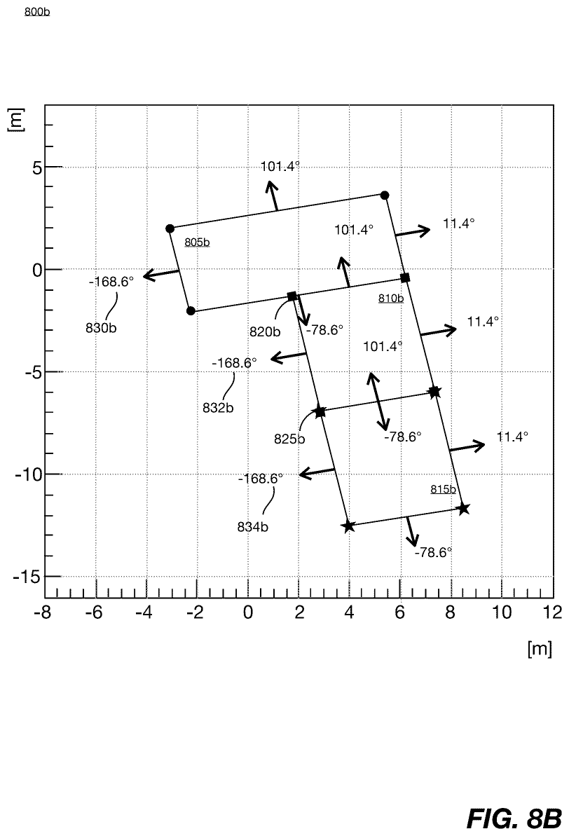

Once the cost function is established, it can be optimized by, e.g., computing a gradient of the function and performing gradient descent. Where the cost function takes into account interaction of the hypernodes 510, 520 or the digital twin nodes 311-323 (or otherwise involves the activation functions of the underlying digital twin 300), the activation function gradients may be available for the purposes of optimization by virtue of implementation with differentiable programming, or otherwise may be computed as needed according to any suitable method. Another method of determining cost functions is described with reference to FIGS. 8-10 and the surrounding text.

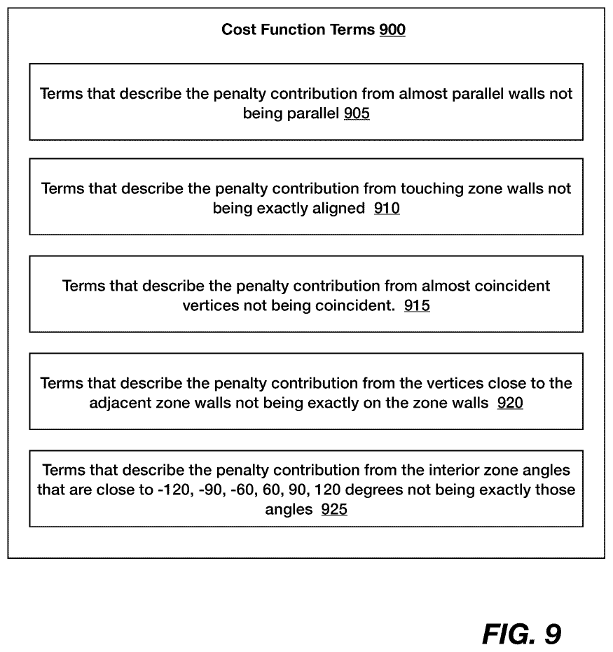

It will be apparent that the correction of wall orientations to square off room corners is but one example application for correction of a digital twin using the techniques described herein. Numerous additional applications and corresponding modifications (e.g., to the hypergraph 500, the constraints realized by the cost function, or the tunable variables provided in the cost function) for implementing such corrections or other applications will be apparent. For example, to align two separately captured rooms, a cost function penalty term can be established between any two walls that are sufficiently close and roughly parallel that will move the walls to be parallel and at a distance apart from each other that is equal to the expected intra-wall depth. The cost function may also be established to penalize any changes that move other wall angles aways from square, thereby preserving room geometry; in other words, as the optimization moves one wall, the others will be moved with the first. Thus, the techniques presented herein are generalizable to other problems. FIG. 9 and the surrounding text describes some ways to construct cost functions.

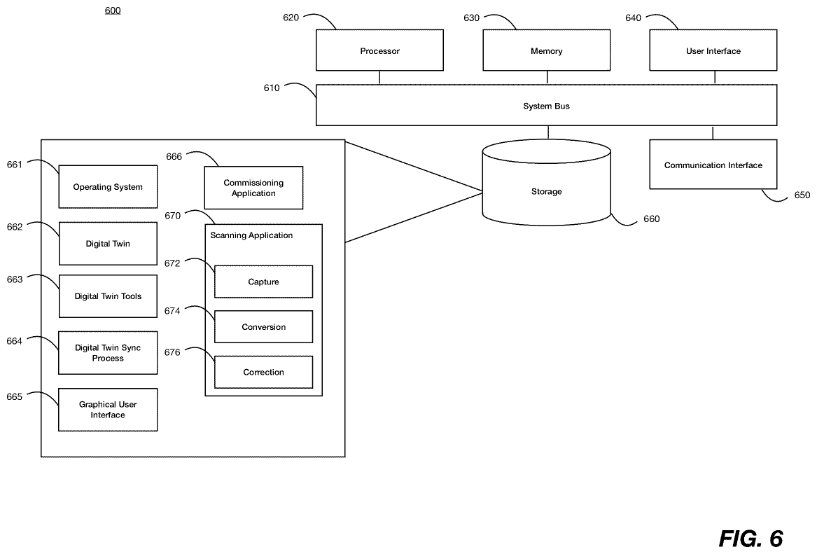

FIG. 6 illustrates an example hardware device 600 for implementing a digital twin mobile device. The hardware device 600 may describe the hardware architecture and some stored software of a device providing a digital twin mobile suite 130 or the digital twin mobile device 200. As shown, the device 600 includes a processor 620, memory 630, user interface 640, communication interface 650, and storage 660 interconnected via one or more system buses 610. It will be understood that FIG. 6 constitutes, in some respects, an abstraction and that the actual organization of the components of the device 600 may be more complex than illustrated.

The processor 620 may be any hardware device capable of executing instructions stored in memory 630 or storage 660 or otherwise processing data. As such, the processor 620 may include a microprocessor, field programmable gate array (FPGA), application-specific integrated circuit (ASIC), or other similar devices.

The memory 630 may include various memories such as, for example L1, L2, or L3 cache or system memory. As such, the memory 630 may include static random access memory (SRAM), dynamic RAM (DRAM), flash memory, read only memory (ROM), or other similar memory devices. It will be apparent that, in embodiments where the processor includes one or more ASICs (or other processing devices) that implement one or more of the functions described herein in hardware, the software described as corresponding to such functionality in other embodiments may be omitted.

The user interface 640 may include one or more devices for enabling communication with a user such as an administrator. For example, the user interface 640 may include a display, a mouse, a keyboard for receiving user commands, or a touchscreen. In some embodiments, the user interface 640 may include a command line interface or graphical user interface that may be presented to a remote terminal via the communication interface 650 (e.g., as a website served via a web server). In some embodiments, the user interface may include additional hardware or hardware in combination with software such as, for example, a camera, a LiDAR device, or a light source.

The communication interface 650 may include one or more devices for enabling communication with other hardware devices. For example, the communication interface 650 may include a network interface card (NIC) configured to communicate according to the Ethernet protocol. Additionally, the communication interface 650 may implement a TCP/IP stack for communication according to the TCP/IP protocols. Various alternative or additional hardware or configurations for the communication interface 650 will be apparent. In some embodiments, the communication interface 650 may include a radio interface for communicating according to a LTE, 5G, or Bluetooth protocol.

The storage 660 may include one or more machine-readable storage media such as read-only memory (ROM), random-access memory (RAM), magnetic disk storage media, optical storage media, flash-memory devices, or similar storage media. In various embodiments, the storage 660 may store instructions for execution by the processor 620 or data upon with the processor 620 may operate. For example, the storage 660 may store a base operating system 661 for controlling various basic operations of the hardware 600.

The storage 660 additionally includes a digital twin 662, such as a digital twin according to any of the embodiments described herein. As such, in various embodiments, the digital twin 662 includes a heterogeneous and omnidirectional neural network. A digital twin tools library 663 may provide libraries for various advanced functionalities with respect to the digital twin 662 such as, for example, introspecting a digital twin (including building of a hypergraph, executing queries, or managing broadcast keypaths); or constructing and optimizing cost functions for problem solving. A digital twin sync process 664 may communicate with other devices via the communication interface 650 to maintain the local digital twin 662 in a synchronized state with digital twins maintained by such other devices. Graphical user interface instructions 665 may include instructions for rendering the various user interface elements for providing the user with access to various applications. As such, the GUI instructions 665 may correspond to one or more of the scene manager 232, UI tool library 234, user interface 230, or portions thereof. Commissioning application instructions 666 may correspond to the commissioning application 254 and, as such, may include instructions for identifying devices from the digital twin 662 for commissioning; guiding a user in the commissioning process, activating and communicating with such devices; or performing other activities related to activation, testing, and installation verification of devices.

Scanning application instructions 670 may correspond to the scanning application 252 and, as such, may include instructions for capturing a surrounding environment and digesting it into the digital twin 662 for use as a building information model, in simulations, and generally by any other applications that have use for the digital twin 662 and structural information modeled thereby. The scanning application instructions 670 include multiple sets of sub-instructions 672, 674, 676 for realizing various functionalities. Capture instructions 672 are configured to control a LiDAR or other depth sensing device to capture a 3D scan of a surrounding environment. The capture instructions 672 may also interact with the GUI instructions 665 to guide or assist the user in performing this capture. Conversion instructions 674 are configured to convert the 3D scan data created by the capture instructions 672 into a floorplan (e.g., a set of arranged walls, windows, doors, open spaces, or other structural features). The conversion instructions 674 may further interact with the digital twin tools 663 to update the digital twin 662 to carry this scanned information. Correction instructions 676 may be configured to perform various corrections of the floorplan as captured in the digital twin 662 such as ensuring expected wall angles and relative placement of rooms. Accordingly, the correction instructions 676 may interact with the digital twin tools to construct a hypergraph, create a cost function, and tune the digital twin by minimizing the cost function to perform such corrections.

While the hardware device 600 is shown as including one of each described component, the various components may be duplicated in various embodiments. For example, the processor 620 may include multiple microprocessors that are configured to independently execute the methods described herein or are configured to perform steps or subroutines of the methods described herein such that the multiple processors cooperate to achieve the functionality described herein, such as in the case where the device 600 participates in a distributed processing architecture with other devices which may be similar to device 600. Further, where the device 600 is implemented in a cloud computing system, the various hardware components may belong to separate physical systems. For example, the processor 620 may include a first processor in a first server and a second processor in a second server.

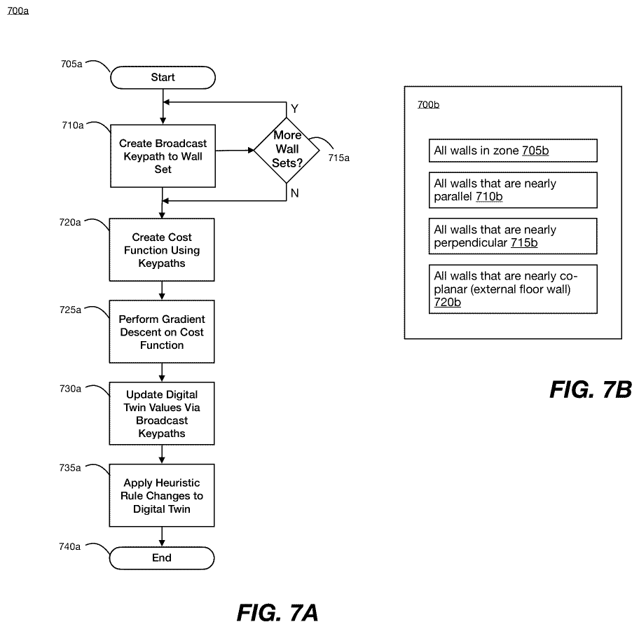

FIG. 7A at 700a illustrates an example method 700a for correcting a digital twin. The method 700a may correspond to the correction instructions 676 and, as such, may be suited to correcting inaccuracies or other deviations from expectations imparted into the digital twin by the scanning application instructions 670. The method begins in step 705a (e.g., in response to the completion of an execution of the conversion instructions 674, on manual request by a user, or based on a trigger from some other application desiring some form of correction to the structure captured in the digital twin 662). The method 700a proceeds to step 710a where the device begins building the hypergraph for the particular corrections to be performed. In the present example, the device creates a broadcast keypath to reference a set of walls. In step 715a, it is determined if there are more wall sets.

FIG. 7B at 700b describes certain wall sets that may have broadcast paths created to correct a floor within a digital twin. The walls sets may be all the walls within a zone 705b. A zone may contain the walls with a single room. Another wall set that may be created is all the walls on a floor (or other space that is to be aligned) that are nearly parallel 710b. “Nearly parallel” is an adjustable parameter. In some embodiments, “nearly parallel” indicate clusters of walls such that the walls make angles at most 15° apart. Similarly, all the walls that are nearly perpendicular 715b constitute another wall set. “Nearly perpendicular” is an adjustable parameter. In some embodiments, “nearly perpendicular” indicate clusters of walls such that the walls make angles at 90°+−15°. The wall set of “all the walls that are nearly co-planar,” 720b are outside walls that are nearly parallel and are almost in the same plane. This is an adjustable parameter. In some embodiments, the walls in this set are almost in the same plane, give or take 0.2 m. In other embodiments, the amount of give and take is either larger or smaller, depending on need. Larger spaces may need more leeway, tiny spaces less.

Back to step 715a, if there are more wall sets, then the method returns to 710a, where a broadcast keypath is set up for that wall set. It will be apparent that a different number of references (e.g., keypaths or broadcast keypaths) may be established for different types of corrections and that, further, such references may be made to objects other than digital twin nodes representing walls.

Having established the appropriate broadcast keypaths, the method 700a proceeds to step 720a where the device creates a cost function using those references. The cost function created in this step 720a dependent on the correction to be performed. In particular, the constraints to be met (i.e., the expressions of what “correct” means) may correspond to one or more terms to be included in the cost function. For example, where the constraint is that “substantially perpendicular walls should be corrected to be 90 degrees,” a term that compares these angles (as computed using the keypaths established in steps 710a, 715a) to 90 degrees and penalizes deviation therefrom may be included. As another example, where the constraint is that “the distance between parallel adjacent walls should be 4.5 inches,” a term that compares this distance (as computed using the keypaths established in steps 710a, 715a) and penalizes deviation therefrom may be included. Various methods for correlating a constraint to a set of cost function terms will be apparent. For example, in some embodiments, the available constraints may be stored as enumerated values which may be correlated by way of a lookup table to one or more cost function terms. In this manner, a cost function may be constructed for multiple constraints at a single time by identifying all constraints to be met and including all cost function terms associated with any such constraint in the cost function to be optimized. Various alternative approaches will be apparent for translating a constraint to a cost function. Some alternative approaches for translating constraints to cost functions are shown with reference to FIGS. 8-10 and the surrounding text.

In step 725a, the device optimizes the cost function by, for example, performing gradient descent. As will be understood, the gradient descent process may locate a local minimum (which may not be a global minimum but at least may constitute an improvement on a starting state) on the cost function. It will be understood that the terms “optimize” and “correct” may not necessarily imply that the constraints have been totally met, but rather that the satisfaction of the constraint has been improved. In other words, the chosen optimization method may only find a local minimum, when a better global minimum exists. In some embodiments, additional optimization techniques may be used to increase the chances of finding the global minimum of the cost function or, at least, a “better” local minimum.

The values that optimize this cost function are the values that may correspond to corrected geometry. These may then be written back (e.g., via the keypaths established in steps 710a, 715a) to the digital twin in step 730a. In some embodiments, the step of 725a may tune the values of the digital twin directly as part of the optimization process and, as such, the write-back step 730a may be omitted. Finally, in step 735a, the device may apply one or more heuristic rule for additional corrections not otherwise handled by the optimization procedure described above. For example, a heuristic rule may specify that “if two wall nodes are parallel and 4.5 inches apart, they should be combined into a single wall node.” Thus, the optimization process of steps 725a, 730a may place the digital twin in a state where one or more heuristic rules are applicable (e.g., where the two wall nodes were not parallel or sufficiently close prior to correction). The method 700a then proceeds to end in step 740a.

FIG. 8A illustrates an example interface 800a illustrating an uncorrected floorplan that will be used in connection with the cost function examples of FIG. 9. FIG. 8B illustrates a corrected floorplan after the methods described in FIG. 9 are used. The interface 800a may be shown by the scene manager 232 as part of an interface for the scanning application 252. For example, the interface 800a may be displayed as an in-progress scan in a minimap such as minimap 160 or may be part of another view that illustrates a floorplan that has been captured. As such, the interface 800a may constitute a rendering of a portion of a digital twin 120, 210, 300 describing, e.g., three rooms of a building.

As shown, the interface 800a illustrates the perimeters of three rooms 805a, 810a, 815a. These rooms 805a, 810a, 815a may correspond to zone nodes in a digital twin 300. In various embodiments, the information captured in the digital twin 300 may not be entirely accurate in relation to a real world structure or may otherwise not conform to various user expectations. Such inaccuracies may be imparted due to user error, imperfection or errors in the scanning application 252, or any other source. For example, an angle 832a between two walls of the second room 410a may not be a right angle. This may be considered incorrect either because the real world room corner forms a right angle or because, while the real world room corner is not precisely a right angle, the user will expect a right angle. This inaccuracy may be indicative of incorrect data stored in the digital twin. For example, vertices or orientation properties stored in the exterior wall node, e.g., 311, may be incorrect.

As another example of an imperfection, the three rooms 805a, 810a, 815a may be positioned or oriented incorrectly with respect to each other. This may be indicated by the angle 832a between the adjacent walls being non-parallel or by the distance 834a between the walls being more than an expected amount (e.g., the typical substantially 4.5 inch interior wall depth for most constructions). Each room in the diagram has its vertices represented by a different marker. The room 805a has its vertices represented by a dot; 810a by a square, and 815a by a star. Each vertex is represented by a keypath. So, for example, room 805a has four keypaths representing its four vertices, their locations indicated by the dots.

FIG. 9 is a block diagram describing some methods of creating cost functions, such as those performed in method 700a, where a device creates a cost function to correct misaligned walls, the walls being stored within a digital twin, e.g., 300.

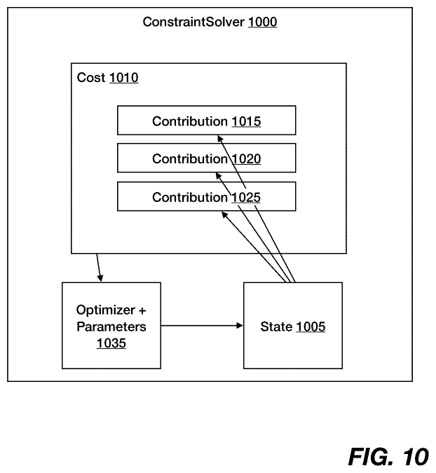

Misaligned floor plan geometry, such as those shown with reference to FIG. 8A, can be parametrized either in terms of vertices of the floor walls or their positions and orientation angles. The vertices may be fetched from the digital twin 300, and may involve the keypaths described within reference to FIGS. 5 and 10. The digital twin may store the vertices to each room in x,y,z, format, or another format. The positions may be stored in another format that may be parameterized to an x, y, z format. In some embodiments, the vertices are parameterized to an x, y format. Once parameterized, they can be significantly improved by requiring the geometry to follow a set of rules and then adjusting the vertex positions, and thus, correspondingly, the wall positions and angles, to satisfy the rules in the best way possible. This may be performed by constructing smooth penalty cost functions, each function corresponding to a specific type of the geometry violation, and then minimizing the weighted sum of the penalty cost functions using a gradient descent method. The penalty-based geometrical optimization that uses gradient descent to minimize the penalties due to the errors in geometrical alignment can be used, e.g., where the correct geometry rules are known, where there exist smooth parameters that can be adjusted to correct the geometry, and where the deviations from the correct rules of the geometry can be characterized by smooth penalty functions.

The geometry optimization described with reference to FIG. 9 may involve the following alignments:
a. walls that are nearly parallel are made parallel;
b. adjacent zone edges that are nearly parallel and are close to each other are made coincident with each other;
c. vertices that are nearly at the same positions are made to be at the same positions;
d. vertices that are close to the adjacent zone walls are made to lie on the adjacent zone edges; and
e. angles within each zone that are close to being −120, −90, −60, 60, 90, 120 degrees are made to match those angles.

The cost function, e.g., 720a, may be built that represents the constraints in terms of (x, y) coordinates of the vertices. These vertices may be derived using keypaths, as discussed with reference to FIG. 5. Alignment hyperparameters depend on the specific application of the cost function. In the instant implementation, to correct the geometry of rooms that were introduced by scanning using camera and lidar based approaches, various hyperparameters, such as angular scales 15°, 0.1°, 0.01°, and the distance scales 1 m and 1 mm are used. These have been determined empirically to work for aligning building wall models. In other embodiments other hyperparameters are used. For example, in larger installations, such as warehouses, distance scales 5 m and 5 mm may be used. Slightly different angular scales may be used, as well.

One set of cost function terms are those that describe the penalty contribution from almost parallel wall not being parallel 905. To determine these terms, clusters of wall surface normal vectors are found such that within each of the clusters, any two vectors are no more than 15° apart. Four such clusters are shown with reference to FIG. 8A, {N1, N2, N3}, {S1, S2, S3}, {E1, E2, E3}, and {W1, W2, W3}. Within each cluster, having a non-zero angle γ within any pair of different surface normal vectors is penalized by a term

$$+ {[ \frac{γ}{0.1 °} ]}^{2} .$$

Such terms are summed over every pair of different vectors within each cluster, then the sums are combined over all clusters of parallel walls.

Another set of cost function terms 910 describe the penalty contribution from touching zone walls not being exactly aligned. The angle between the surface normal vectors of any two adjacent zone walls should be 180 degrees. The deviation from this is effectively penalized via cost function terms such as

$${[ \frac{γ - 180 °}{0 \text{.01} °} ]}^{2} .$$

The cost function terms 915 describe the penalty contribution from almost coincident vertices not being coincident. All pairs of vertices that are almost coincidental are determined. In some embodiments, “almost coincidental” may mean those that have been found to be within one meter of each other. In some embodiments, a different distance is chosen. From every such pair of vertices, a penalizing term is added to the cost function

$$+ \frac{( {( {x}_{1} - {x}_{2} )}^{2} + {( {y}_{1} - {y}_{2} )}^{2} )}{1 {mm}^{2}} ,$$

where (x₁, y₁) and (x₂, y₂) are the coordinates of the two vertices in each pair.

The cost function terms 920 describe the penalty contribution from the vertices close to the adjacent zone walls that are not exactly on the zone walls. Let d be the distance from a vertex V to the adjacent edge. Then, a penalty term is added to the cost function

$$+ {[ \frac{d}{1 mm} ]}^{2} .$$

The cost function terms 925 describe the penalty contribution from the interior zone angles that are close to −120°, −90°, −60°, 60°, 90°, and 120°, but are not exactly those angles. Within each zone—e.g. room, consider the differences of the surface normal vector angles between the adjacent walls, going in counter-clock-wise direction around the zone. Call that the angular difference. Determine which of the intended angles [−120, −90, −60, 60, 90, 120] was the initial difference closest to and call that angle δ₀. For the example in the picture, bottom right corner 825a, δ=surface normal 815a 18.3°—surface normal 820a—71.7° to equal 89.4°. Here, the intended angle is δ₀=90°. The penalty contribution to the cost function from the internal angles not being equal to the intended angles is

$$+ {[ \frac{δ - {δ}_{0}}{0 \text{.01} °} ]}^{2} .$$

With reference to FIG. 7, at 725a, in some embodiments, when gradient descent is performed, the cost function is minimized by varying the coordinates of the vertices.

FIG. 8B illustrates an example interface illustrating a corrected floorplan 800b. Once gradient descent has been performed on the floorplan of FIG. 8A, the rooms 805b, 810b, and 815b may have the rooms aligned such that the overlapping vertices overlap properly, such as at corners 820b and 825b. The walls may be parallel as shown by the identical unit normal vectors, e.g, 830b, 832b, and 834b, all −168.6°

FIG. 10 is a block diagram describing some aspects of a constraint solver, such as those that will optimize the combined cost function. Such a constraint solver may consist of constraints 900 that may be used to correct misaligned walls, the walls being stored within a digital twin 300.

The State 1005 may be a structural aspect of a building, such as the vertices of a structure that is to be optimized, like the uncorrected floorplan 8A. These vertices may be determined using keypaths, as discussed with reference to 720a and to FIG. 11 and the surrounding text. The cost function 1010 may have contributions 1015, 1020, 1025, that are one or more of the cost function terms 905-925. These contributions may utilize the state (e.g., vertices). The cost 1010 is then optimized using the optimizer and parameters, as discussed with reference to, e.g., performing gradient descent to minimize the cost function 725a. The state, (the vertices in the instant embodiment), may then be updated using the values that optimize the cost function. In other words, this constraint solver finds the appropriate state, determines the cost function 1010, and then runs the optimizer 1035 until some stopping state that corresponds to the optimized cost is reached. The state values 1005, when the stopping state is reached, may be the vertices that are used to produce the corrected floorplan 8B. These state values may then replace the values in the digital twin 120, 210, 300, thus correcting the floorplay geometry in the digital twin 120, 210, 300.

FIG. 11 is an exemplary digital twin graph, together with a hypergraph that contains hypercompute nodes 1105 that may be used to transform an uncorrected floorplan, e.g., 8A to a corrected floorplan, e.g., 8B. The transformation may be performed on a digital twin 120, 210, 300. This graph may identify the parameters to optimize, which will also be the parameters that are varied. These may be vertices in a floorplan, e.g., 8A. A set of v vertices may be x 1120, y 1121, z 1122. These may be the vertices for example, a zone, e.g., 310, which may correspond to the vertices of a room, e.g., one of the three rooms 805a, 810a, 815a, of FIG. 8A. The instant example includes only a single vertex for ease of reading. This vertex (e.g., the variables a 1125, b 1126, c 1127) may be referenced in a keypath. A lens (e.g., 510) is a bag of keypaths that allows accessing data elements of interest in a much larger graph. Lens A 1130, lens B 1131, and lens C 1132 may be used to view a 1125, b 1126, and c 1127. These specific example lenses provide keypaths to a single variable, but others may provide multiple keypaths to multiple variables. An example of such a bag of keypaths may be those in a larger grouping, such as all of the keypaths in a wall, a room, or some other structure, such as the rooms in FIG. 8A already mentioned. More information may also be found with relation to FIG. 5 and the associated text. In the instant example, lens C only contains keypaths to object c 1127. A keypath may be read-only 1110, or writable 1111. If writable, a variable, such as the variable a 1125, can be changed. Some keypaths 1100 may also allow the original value x 1120 to be changed.

The keypaths (e.g., a 1125, b 1126, and c 1127) are fed through the lenses 1130, 1131, 1132 to constraint nodes 1135, 1136, 1137. These constraint nodes set up the cost functions (e.g., 900) that will be minimized. Each constraint node points to the lens associated with the values that they need. For example, constraint Node 1 1135 only uses the value of lens A 1130; constraint Node 2 1136 uses values from lens A 1130, lens B 1131, and lens C 1132, while constraint node 3 uses values from lens B 1131 and lens C 1132. Referring to FIG. 8A, in another example, a first lens may point to room 805a, a second lens to room 810a, and a third lens to room 815a. These lenses bring the keypaths to the vertices in these rooms. Each lens may therefore have four vertices associated with it, for the four corners of each room. A constraint node may have the term 905 that gives the rooms straight angles. Another constraint node may be created that ensures that attaching walls are to be parallel 910. Such a constraint node would point to the two lenses representing the two rooms that touch, e.g., room 805a and 810a and would add a penalty term to the cost function for touching walls not being parallel 910. Many other constraint nodes may be added as well. The constraint solver 1140 then queries the constraint nodes, discovers their cost function contributions (e.g., 1015, 1020, 1025), and discovers their lenses that are needed for reading the variables (a 1125, b 1126, and c 1127) needed to compute the cost function. The cost function is then computed as described with reference to FIG. 7 725a; e.g., it may use gradient descent to determine the minimum. Once the cost function has been minimized, the lens modifies the original vertex values 1120, 1121, 1122 to the new values. The mutation lens (in this case, 1130, 1131, 1132) allows mutating the variables a 1125, b 1126, and c 1127 through their writable keypaths. This mutation modifies the model graph from the original picture 8A to the new, improved picture 8B.

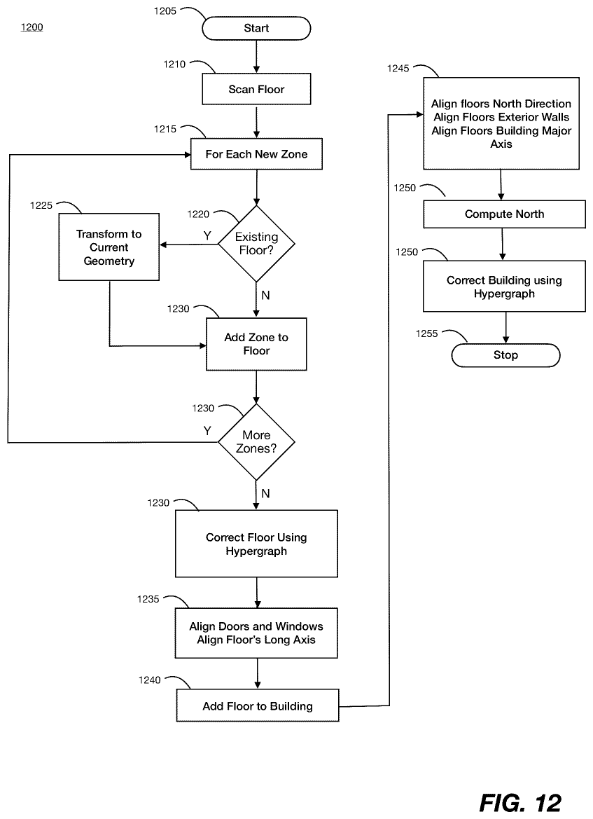

FIG. 12 illustrates an example method 1200 for floor scanning and alignment logic flow. The method 1200 may correspond to the correction instructions 676 and, as such, may be suited to correcting inaccuracies or other deviations from expectations imparted into the digital twin by the scanning application instructions 670. The method beings in step 1205 (e.g., in response to the completion of an execution of the conversion instructions 674, on manual request by a user, or based on a trigger from some other application desiring some form of correction to the structure captured in the digital twin 662). The method 1200 proceeds to step 1210, where a floor is scanned. Scanning a floor is described in U.S. patent application Ser. No. 17/459,084, filed on Sep. 15, 2021, now U.S. Pat. No. 11,989,895, and U.S. patent application Ser. No. 17/982,321, filed Nov. 7, 2022, the entire disclosures of which are hereby incorporated herein by reference. The floor is generally scanned as a series of zones. These zones generally correspond to rooms, such as the three rooms shown with reference to FIGS. 8A and 8B. Once a floor is scanned, each zone will be processed separately. For each new zone in the floor scan 1215, the method moves to decision point 1220 whether it is determined if this zone belongs to an existing floor. If no, the zone is not in an existing floor, then the method continues at 1230, where the scan is added to a newly created instance of a floor. If yes, then at 1225 the zone may need to be transformed to the orientation of the existing floor before being added to the existing floor. Next, at decision point 1230, if there are more zones, the method continues at 1215. If there are no more zones, then at 1230, certain corrections are performed on the floor to align the individual zones. These may include aligning the floor geometry by performing constraint solving on vertices (e.g., using a hypergraph as shown with reference to FIG. 11) followed by non-computationally intensive rigid alignments at 1235, where the doors and the windows are brought to the same heights, and the floor's X axis is aligned to be along its longer axis. The method then continues at 1240, where the floor is added to the building. At 1245, the floor is corrected to more closely fit the building by some methods that are less computationally intensive than calculating a cost function using gradient descent, similar to those methods performed at 1235. In this case, some of the methods that may be used include aligning the floors in a north direction, aligning the floors' exterior walls, and aligning the floors along the major axis of the building. Then, at 1250, north is computed to ensure the building is correctly positioned in space after the alignment of 1245. This, 1250, may correct the building using a hypergraph. Specifically, using a hypergraph, a constraint solver 1000 with cost function terms 900 gathered in constraint nodes 1135, 1136, 1137 uses gradient descent to simultaneously align all the floors across the building. At 1255, the method ends.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain example aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the scope of the claims.

We claim:

1. A method for correcting a digital twin of a physical structure, the method comprising:
determining a state to be optimized;
accessing keypaths for the state in the digital twin;
constructing constraints using the keypaths;
constructing a cost function for the state using the constraints; and
optimizing a value for the state using the cost function, whereby the state stored in the digital twin is corrected.

2. The method of claim 1, wherein the keypaths access a plurality of like states from different parts of the digital twin,
whereby optimizing the value comprises optimizing respective values of the plurality of like states.

3. The method of claim 2, wherein the keypaths comprises a query for selecting the different parts of the digital twin from which the plurality of like states are accessed.

4. The method of claim 1, wherein the state is a structural property.

5. The method of claim 4, wherein the structural property is a vertex.

6. The method of claim 4, wherein the constraint specifies a penalty for almost parallel walls not being parallel.

7. The method of claim 4, wherein the constraint comprises a penalty for vertices in touching zones not being exactly aligned.

8. A device for creating a digital twin of a physical structure, the device comprising:
a depth sensor;
a memory; and
a processor configured to:
obtain, from the depth sensor, a scan data descriptive of the physical structure,
convert the scan data to a digital twin,
store the digital twin in the memory,
determine a state to be optimized;
access keypaths for the state in the digital twin;
construct a constraint using the keypaths;
construct a cost function for the state using the constraint; and
optimize a value for the state using the cost function, whereby the state stored in the digital twin is corrected.

9. The device of claim 8, wherein the keypaths access a plurality of like states from different parts of the digital twin,
whereby optimizing the value comprises optimizing respective values of the plurality of like states.

10. The device of claim 9, wherein the state is a structural property.

11. The device of claim 10, wherein the structural property is a vertex.

12. The device of claim 11, wherein the constraint comprises a penalty for almost coincident vertices in walls that should be touching not being exactly aligned.

13. The device of claim 11, wherein the constraint specifies that a distance between interior zone angles not being exactly −120 degrees, −90 degrees, −60 degrees 60 degrees, 90 degrees or 120 degrees.

14. The device of claim 8, wherein there are more than one constraint, and wherein the more than one constraint are summed in the cost function.

15. A non-transitory machine-readable storage medium encoded with instructions for execution by a processor for correcting a digital twin of a physical structure, the non-transitory machine-readable storage medium comprising:
instructions for determining a state to be optimized;
instructions for accessing keypaths for the state in the digital twin;
instructions for constructing a constraint using the keypaths;
instructions for constructing a cost function for the state using the constraint; and
instructions for optimizing a value for the state using the cost function, whereby the state stored in the digital twin is corrected.

16. The non-transitory machine-readable storage medium of claim 15, wherein the keypaths access a plurality of like states from different parts of the digital twin,
whereby optimizing the value comprises optimizing respective values of the plurality of like states.

17. The non-transitory machine-readable storage medium of claim 16, wherein the state is a structural property.

18. The non-transitory machine-readable storage medium of claim 17, wherein the structural property is a vertex.

19. The non-transitory machine-readable storage medium of claim 18, wherein the constraint comprises a penalty for almost coincident vertices in walls that should be touching not being exactly aligned.

20. The non-transitory machine-readable storage medium of claim 18, wherein the constraint specifies that a distance between interior zone angles not being exactly −120 degrees, −90 degrees, −60 degrees 60 degrees, 90 degrees or 120 degrees.
